(19) United States
(12) Patent Application Publication
(10) Pub. No.: US 2010/0001089 A1
(43) Pub. Date: Jan. 7, 2010

(54) METHODS AND SYSTEMS FOR PROMOTING PRECIPITATION FROM MOISTURE-BEARING ATMOSPHERIC FORMATIONS

(76) Inventors: Arturo Vazquez Serrano, Anaheim, CA (US); Enrique Ugalde Guerrero, Mexico City (MX); Domingo Ferrer Vivo, Mexico City (MX); Ricardo Ramos Zaragoza, Tepic Nayarit (MX)

Correspondence Address: Steinfl & Bruno, 301 N Lake Ave Ste 810, Pasadena, CA, 91101, US

(21) Appl. No.: 12/166,281

(22) Filed: Jul. 1, 2008

(51) Int. Cl. A01G 15/00; B64D 1/16; B01D 53/26

(52) U.S. Cl. 239/2.1; 239/14.1; 244/136; 516/114

(57) ABSTRACT

Methods and systems for promoting precipitation from moisture-bearing atmospheric formations are described. A composition comprising a precipitation stimulating material and a volatile liquid agent is located on an aircraft and subject to one or more aircraft-generated pressures during aspersion. A first pressure is a pressure for expelling the composition from the aircraft. A second pressure results from combination between air and aircraft velocity. A third pressure is an ascending pressure resulting from expelling the composition from the aircraft at a lift portion location of the aircraft where only a lift force is applied to the aircraft during flight.

### TECHNICAL FIELD

The present disclosure relates to promotion of precipitation. More in particular, it relates to methods and systems to promote precipitation from a moisture-bearing atmospheric formation.

### BACKGROUND

Methods and systems directed to promote precipitation from atmospheric moisture-bearing formations have been described that are based on the use of certain precipitation promoting materials.

According to a first approach, lumps of silver iodide were burned on a special combustion device, in order to disaggregate the crystals, and after that they were inserted into moisture bearing atmospheric formations, producing snowflakes, by the principle of induced crystallization.

According to a second approach, silver iodide or lead iodide crystals were diluted in an organic volatile solvent, such as ether or acetone, with or without a dispersing agent and were introduced by gravity in the moisture bearing atmospheric formations to promote rainfall.

Moreover, according to both the first and second approach, the temperature of the moisture bearing atmospheric region must be within a certain range, for the iodide crystals to cause precipitation.

### SUMMARY

Provided herein, are compositions, methods and systems for stimulating precipitation in a moisture-bearing atmospheric formation at any temperature and with additional advantages over the art that will be evident to a skilled person upon reading of the present disclosure.

According to a first aspect, a method for stimulating a moisture-bearing atmospheric formation to cause precipitation is provided. The method is based on the use of a composition comprising a precipitation stimulating material and a volatile liquid vehicle, with the stimulating material substantially unsolubilized in the volatile liquid vehicle. In this method, the composition is contacted with the atmospheric moisture bearing formation for a time and under conditions to create a temperature difference between the moisture-bearing atmospheric formation before contact and the moisture-bearing atmospheric formation after contact from about 40° C. to about 110° C.

According to a second aspect a method for stimulating a moisture-bearing atmospheric formation to cause precipitation is provided. The method is based on the use of a composition comprising a precipitation stimulating material and a volatile liquid vehicle, with the stimulating material substantially unsolubilized in the volatile liquid vehicle. In this method, the composition is contacted with the atmospheric moisture bearing formation for a time and under conditions to create a temperature difference between the precipitation stimulating material and the moisture-bearing atmospheric formation, the temperature difference promoting moisture condensation in the atmospheric formation, independently of the temperature of the moisture-bearing atmospheric formation.

According to a third aspect, a method for stimulating a moisture-bearing atmospheric formation to cause precipitation is provided, the method comprising: providing a composition comprising a precipitation stimulating material; locating the composition on a flying device; contacting the composition with the moisture-bearing atmospheric formation by subjecting the composition to one or more pressures generated by the flying device, wherein the subjecting the composition to one or more pressures generated by the flying device creates a temperature difference between the moisture-bearing atmospheric formation before contact and the moisture-bearing atmospheric formation after contact, such temperature difference causing precipitation independently of the temperature of the moisture-bearing atmospheric formation.

According to a fourth aspect, an arrangement for stimulating a moisture-bearing atmospheric formation to cause precipitation is provided, the arrangement comprising: a composition comprising a precipitation stimulating material; a nozzle from which the composition is adapted to be expelled, the nozzle located on a flying device; a pressure generation system for subjecting the composition to one or more pressures generated by the flying device to create a temperature difference between the precipitation stimulating material and the moisture-bearing atmospheric formation, the temperature difference causing precipitation independently of the temperature of the moisture-bearing atmospheric formation.

According to a fifth aspect, a system for stimulation of moisture-bearing atmospheric formations to cause precipitation is provided, comprising: an aircraft, the aircraft comprising a lift portion where only lift force is applied during flight; and a nozzle adapted to expel, during flight of the aircraft, a composition comprising a precipitation stimulating material and a volatile liquid agent, the nozzle being located on the lift portion of the aircraft, wherein location of the nozzle on the lift portion of the aircraft allows application of an ascending pressure on the precipitation stimulating material and volatile liquid agent during flight as soon as the precipitation stimulating material and volatile liquid agent are expelled from the nozzle.

According to a sixth aspect, a composition is provided, comprising: a precipitation stimulating material combined with an organic solvent, the precipitation stimulating material being selected from silver iodide in a proportion of 8 to 25 grams per liter of solvent and lead iodide in a proportion of 8 to 25 grams per liter of solvent, the solvent being selected from ether and acetone.

According to a seventh aspect, a method for preparing a composition of stimulating material suitable for causing precipitation in cloud formations is provided, comprising: providing lumps of metallic iodide crystals; milling the lumps of metallic iodide crystals at a temperature between about 60° C. and about 147° C. to obtain a milled mixture; before combining the milled mixture with an organic solvent, cooling the milled mixture until the milled mixture reaches a temperature below the boiling point of the organic solvent; and combining the cooled milled mixture with the organic solvent.

According to an eighth aspect, a method for moving a cloud under influence of a precipitation stimulating material adapted to contact the cloud is provided, comprising: contacting the cloud multiple times with the precipitation stimulating material to generate multiple condensation points on the cloud, wherein portions of the cloud opposite to a location of each contact move towards said location, thus resulting in movement of the cloud, wherein the precipitation stimulating material is a material adapted to generate a 40° C. to 110° C. temperature gradient between the cloud before the contact and the cloud after the contact.

With the compositions, methods and systems herein described a moisture-bearing atmospheric formation can be stimulated at any temperature, including temperatures above −5° C. and −20° C., and can therefore be used in a wide series of geographical areas, including those where temperatures below −5° C. and −20° C. are very rare and/or not permanent.

The compositions, methods and systems herein disclosed can allow introduction of a precipitation stimulating material in a manner that can advantageously use—but is not necessarily dependent on—gravity.

The compositions, methods and systems herein disclosed can also provide triggering of a reaction inside the moisture-bearing atmospheric formation resulting in an increase of the air humidity that is converted into precipitation from the moisture-bearing atmospheric formation, in comparison with the humidity converted by methods and systems of the art.

The compositions, methods and systems herein disclosed can also allow stimulation of extensive areas that can be significantly larger than areas stimulable by the methods and systems of the art.

The compositions, methods and systems herein disclosed can also allow a stimulating effect on a moisture-bearing atmospheric formation that can last longer than the stimulating effect of methods and systems of the art.

Further, a condensation effect can be created in which the moisture-bearing atmospheric formation tends to replicate the dispersion pattern.

The methods and systems herein disclosed, that are based on a condensation effect in which the moisture-bearing atmospheric formation tends to replicate the dispersion pattern, allow moving of a moisture-bearing atmospheric formation from a first location to a second location.

The methods and systems herein disclosed can also allow increase of the natural pluviosity of a determined region.

In the methods and systems herein disclosed, no combustion and associated development of heath is required to introduce the precipitation stimulating material in the moisture-bearing atmospheric formation. As a consequence, deformation of the precipitation stimulating material and raise in temperature associated with the process of contacting the precipitation stimulating material with the moisture bearing formation are minimized and the percentage of the precipitation stimulating material causing precipitation is increased.

The details of one or more embodiments of the disclosure are set forth in the accompanying drawings and the description below. Other features of the present disclosure will be apparent from the description and drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description, serve to explain the principles and implementations of the disclosure.

FIG. 1 shows introduction of a composition including precipitation stimulating material according to an embodiment of the methods and systems herein described.

FIG. 2 shows an embodiment of the present disclosure where a first pressure is combined with a second ascending pressure during expulsion of the composition or material to promote rainfall.

FIG. 3 shows an embodiment of the present disclosure wherein two pressures are combined with a third ascending pressure during expulsion of the composition or material to promote rainfall.

FIG. 4 shows an exemplary association of compressed air with precipitation stimulating material to favor pressurized expulsion of the material.

FIG. 5 shows a schematical arrangement of a nozzle and a cylinder outside the nozzle to allow air-generated pressure to be used during expulsion of the pressure stimulating material or composition.

FIG. 6 is a schematic figure showing flight dynamic forces and a lift portion of a flying device.

FIG. 7 is a figure showing a possible location on a flying device of a nozzle in accordance with the teachings of the present disclosure.

### DETAILED DESCRIPTION

Compositions, methods and systems are herein disclosed that can stimulate precipitation from a moisture-bearing atmospheric formation such as a cloud formation. The compositions, methods and systems herein described can also provide a significant increase in the amount of rainfall results, and several effects, such as a wider area of application, the ability to move the cloud formations in a desired direction, and the maximization of condensation.

The compositions, methods and systems herein disclosed are based on use of a precipitation stimulating material.

In some embodiments, the precipitation stimulating material is formed by crystals of a metallic iodide, such as lead or silver iodide, which are suspended and dispersed in a solvent, especially an organic solvent, such as a volatile organic solvent like acetone or ether, which is then dispersed in cloud formations.

In embodiments wherein the metallic iodide is lead iodide, stimulation of precipitation by induced crystallization is more efficient, and can be performed at higher temperatures if compared to other metallic iodides. Additionally, use of lead iodide is cost effective and does not affect the environment, since lead iodide has a very stable formula and the proportion that falls to the earth is heavily diluted in water.

Lead iodide can be advantageously used as a precipitation stimulating material because it exploits the principle of induced crystallization in cloud formations already at a temperature of −3° C. and lower. As a first consequence, use of lead iodide allows stimulation of a larger area, mainly through the principle of induced crystallization. A second consequence depends on the fact that the temperature drops by approximately 1° C. each 200 m. Therefore, use of lead iodide allows rainfall stimulation at altitudes that are about 600 m lower than altitudes reachable by other precipitation stimulating materials.

In some embodiments, 7 to 19 grams of silver or lead iodide can be included in one liter of a volatile organic solvent such as acetone or ether. The person skilled in the art will understand that proportions of the iodide and the solvent in the precipitation stimulating material can vary and depend on the amount of rainfall desired. In particular, in embodiments wherein stimulation of rainfall is performed in areas that are prone to flood, a very low concentration of the precipitation stimulating material can be used, even below 7 grams per liter. When instead stimulation of precipitation is performed in areas where the amount of rainfall desired is significantly high (e.g., to fill a dam or to fight a very dry weather to save crops) the proportions can be increased above 19 grams/liter. In some embodiments, the iodide can be in the form of fine crystals.

In accordance with the present disclosure, stimulation of precipitation is associated with creation of a temperature difference or gradient between the precipitation stimulating material (e.g., lead iodide) and the moisture bearing formation (e.g., a cloud). Following introduction in the cloud formation, the violent evaporation of the organic solvent enables chilling of the metallic iodide to a temperature that enables formation of a gradient temperature as herein described. In embodiments where the organic solvent is ether, evaporation of the solvent upon contact of the composition with the moisture bearing formation is particularly endothermic and therefore more effective for the formation of the gradient. In embodiments wherein the organic solvent is acetone, the composition including the silver or lead iodide can be conveniently handled and stored due to the characteristics of the solvent.

In some embodiments, the composition can further include a dispersant or dispersing agent, such as sodium metasilicate, that is able to maintain the crystals distributed in the solvent material so that the solution or suspension is uniform throughout. In particular, the dispersing agent can be used to provide a composition wherein the metallic iodide is finely dispersed in the organic solvent. In some of these embodiments, the composition can include up to 4 ml of a 0.1 normal solution of such dispersant, e.g., sodium metasilicate.

In some embodiments, the composition can be obtained by milling the metallic iodide at a temperature below the temperature when the metallic iodide modifies its crystal structure and then mixing the metallic iodide with the solvent of choice.

In particular, in some embodiments, the milling temperature can be any temperature in the range between about 60° C. and about 147° C. These temperatures help to temporarily control the hydric and electronic avidity of silver iodide without changing its crystal structure. Silver iodide is highly insoluble in water and has a crystalline structure similar to that of ice, allowing it to induce freezing (heterogeneous nucleation) in cloud seeding for the purpose of rainmaking.

The crystalline structure of silver iodide changes with temperature. The following phases are known:

a) up to 420K (147° C.), where silver iodide exists in the so-called β-phase, which has a wurtzite structure. Such structure is suitable for precipitation stimulation, since it is very similar to the structure of ice;

b) above 420K (147° C.), where silver iodide undergoes a transition to the so-called α-phase, which has a body-centered cubic structure and has silver ions distributed randomly between 2-, 3-, and 4-coordinate sites. In such phase, silver iodide is useless for the purpose of induced crystallization.

If temperatures between 60° C. and 147° C. are applied to the silver iodide during milling, the hydro and electric avidity of the silver iodide can be temporarily controlled, thus preventing formation of undesired lumps. In this way, a composition made exclusively of individually disaggregated crystals is formed, much more effective than currently known compositions.

With reference to the milling equipment, the person skilled in the art will understand that there are several industrial grade commercial and laboratory mills, each of them suitable to be operated at the above described temperature range. Such mills will not be described here in detail.

Once milling is completed, silver iodide can be cooled off either naturally or by way of artificial refrigeration, until the silver iodide reaches a temperature below 56.53° C., which is the boiling point of acetone. Usually, silver iodide is cooled off to a temperature of about 40° C.

Once the milled metallic iodide is cooled, it is immersed into a solvent, e.g., acetone (and preferably pharmaceutical grade acetone) in a container, and the container is slightly shaken to completely submerge all the iodide particles. Due to the presence of acetone, the suspension will become homogeneous in about one hour. Care should be taken, during such process, to prevent formation of lumps on one side and to prevent acetone from boiling on the other. Both tasks are usually accomplished by keeping the suspension between 40° C. and 53.56° C.

No particular mixing equipment is required. For example, mixing can occur through shaking or stirring with a metallic or wooden stirrer. With reference to the container, such container is preferably of the type used in carbojet machines, e.g., soda fountains, in order to avoid any kind of reaction between the suspension and the container.

As already mentioned above, metasilicate can be incorporated during the process, to improve the suspension properties of the components.

Usually, the dimensions of the iodide crystals are of less than 0.05 mm. The smaller the dimension of the fine milled crystals, the easier the possibility of aggregation of the iodide in blocks or lumps, and the greater the efficiency of the crystal in stimulating the moisture bearing formation to cause precipitation.

In particular, the reduced dimensions of the crystals milled under the conditions described in the present disclosure and their regularity in shape reduce the hydric and/or electric avidity of the metallic iodides thus minimizing the possibility of aggregation into blocks or lumps. Moreover, the smaller the dimension of the crystals, the more external surface is present in relation to mass. In presence of such additional external surface, a solvent such as acetone is very efficient in producing the desired temperature difference (or gradient) between the cloud formation and the material introduced. As a consequence, the higher the gradient, the higher the rainfall.

Turning now to the application of the precipitation stimulating material to the moisture-bearing atmospheric formation, the precipitation stimulating material is contacted with the moisture-bearing atmospheric formation for a time and under conditions that allow lowering of the temperature of the precipitation stimulating material at a value that allows creation of a sufficient temperature gradient between the material and the cloud formation, to allow occurrence of rainfall from formations at any temperature and at any concentration of humidity.

In particular, moisture condensation can be promoted in moisture-bearing atmospheric formations at temperatures higher, lesser and/or equal to −5° C.

In some embodiments, the temperature difference or gradient can be between 40° C. and 110° C. In particular, given the low temperature of the crystals introduced, the higher the temperature of the cloud formation, the higher the gradient. Average values of the gradient in accordance with the present disclosure are of around 80° C.

There are cases where the cloud formation has a low temperature, e.g., because of the presence of supercooled water, i.e. water at or below its freezing point but in a liquid state. In such cases, the gradient that can be obtained according to the present disclosure is of about 40° C. Presence of supercooled water is preferred, because it induces crystallization of the water.

Introduction of the crystals in the cloud will initiate a reaction wherein the moisture coalesces up to drops big enough to fall to the earth by gravity. In these embodiments, condensation of water droplets induces further condensation and substantial increase in rainfall when compared to methods and systems wherein the above recited gradient between 40° C. and 110° C. is not created.

The result of applying the method according to the present disclosure is that it will cause a substantial increase in the amount of rainfall, when compared with the one produced with existing technologies. A possible explanation that is not intended to limit the scope of the compositions methods and systems herein disclosed is that at temperatures below about −5° C., humidity will create first snowflakes that upon descending will become water drops that will coalesce in bigger water drops. An additional non limiting possible explanation of the effects of the methods and systems herein disclosed is that, at temperatures of the moisture bearing region of the atmosphere above about −5° C., introduction of the crystals in the cloud creates an additional concentration of humidity in the now cold areas of the cloud, and that collision among cold water drops causes formation of bigger drops, thus expelling heat and creating a higher temperature difference.

A further consequence of the teachings of the present disclosure is that clouds can be moved at will during the process, given that a cloud is big enough to avoid from draining while a desired point is reached. In particular, when clouds are stimulated in accordance with the teachings of the present disclosure, the presence of a temperature gradient between 40° C. and 110° C. creates a powerful condensation effect on the cloud. As a consequence, if a cloud is stimulated in a location, the portion of the cloud opposite that location tends to concentrate towards that portion. If such process is repeated in time at selected locations of the cloud, such cloud can be moved in a desired direction. In such case, the movement of the cloud will resemble the way unicellular organisms move, where an analogy can be made between movement of the internal mass of an organism and movement of the moisture of the cloud in a desired direction. After a prolonged stimulation, the shape of the cloud usually resembles the flight pattern of the stimulating aircraft.

The present disclosure will now describe how, in some embodiments, the conditions that create the gradient temperature include applying to the composition (which includes metallic iodides and solvent) a sufficient pressure to favor creation of the desired temperature gradient.

In particular, in some embodiments, the composition is dispersed under pressure by way of a pressure dispersion system, which can be located in an aircraft or other suitable vehicle that allows contacting of the composition with the cloud formation under pressure conditions.

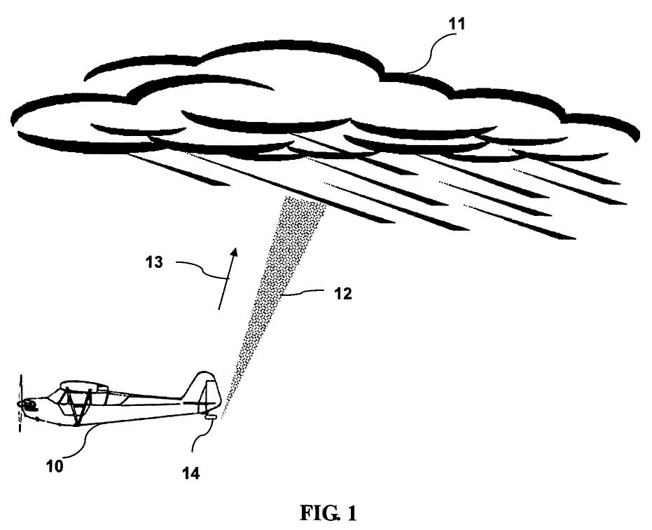

For example, the pressure dispersion system can be configured to apply a single pressure P to expel the composition from the aircraft and contact the cloud formation at a desired pressure, in order to create a desired gradient, as exemplified in the illustration of FIG. 1.

The system of FIG. 1 shows an aircraft (10) (e.g, a Beechcraft Queen Air), a cloud formation (11) and a composition of metallic iodide and solvent (12) expelled towards the cloud formation under a pressure condition, as shown by the orientation (13) of the composition during expulsion. An arrangement to generate such pressure can include any equipment able to generate a pressure to be applied on the composition to expel the composition through an outlet on the aircraft, for example an air compressor. By way of example, the composition can be stored in containers (such as tanks) that can be filled with compressed air. The outlet of the container can instead be provided by a nozzle located anywhere on the aircraft, possibly on locations that do not interfere with the dynamics of the flight. In the embodiment of FIG. 1, the outlet or nozzle (14) is located in the tail section of the aircraft.

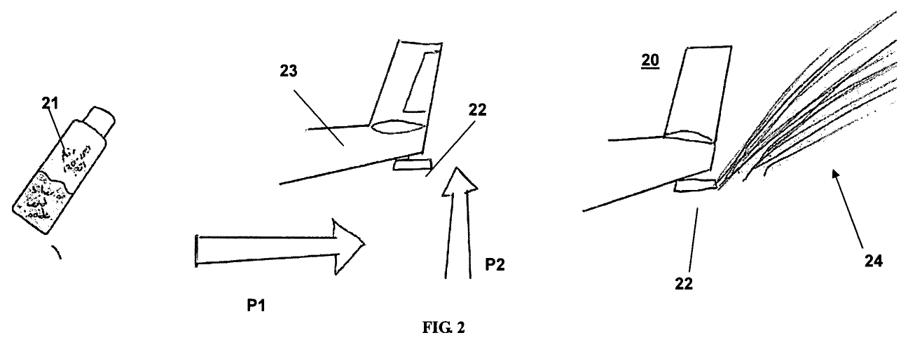

In some embodiments, the pressure dispersion system can be configured and operated as shown in the schematic illustration of FIG. 2. In the illustration of FIG. 2, the system (20) includes a container (21) and a hose (not shown) connecting container (21) to a nozzle (22) mounted on an airplane (23). Container (21) includes the precipitation stimulating material (e.g., silver or lead iodide) suspended in the organic solvent (e.g., acetone) and a gas or other fluid, such as compressed air, to maintain the content under pressure.

In the embodiment of FIG. 2, pressure (P1) is applied to the material to expel the material from the container (21) through the nozzle (22) and pressure (P2) is applied to the material or composition once outside the nozzle (22) to generate a composition dispersion (24). Pressure (P1) and pressure (P2) can be generated through movement and velocity of the aircraft and/or location of the nozzle (22).

In some embodiments, exemplified by the illustration of FIG. 2, pressure (P2) is applied by exposing the composition expelled from the aircraft to an ascending pressure, as described below more in detail.

One or both of pressures (P1) and (P2) can result from the combined application of two or more pressures applied at the same time or at different times to the composition.

In particular, the pressure dispersion system can be based on the coordinated application of three pressures to the composition. The first pressure (composition expulsion pressure) can be applied to the composition to expel the composition from the container towards a nozzle so to be exposed to a second pressure (aircraft speed pressure) resulting from the plane speed on the nozzle, and to a third ascending pressure (nozzle location pressure) that, in some embodiments, can be derived from locating the nozzle in the exact spot of the plane where only an ascending pressure is present.

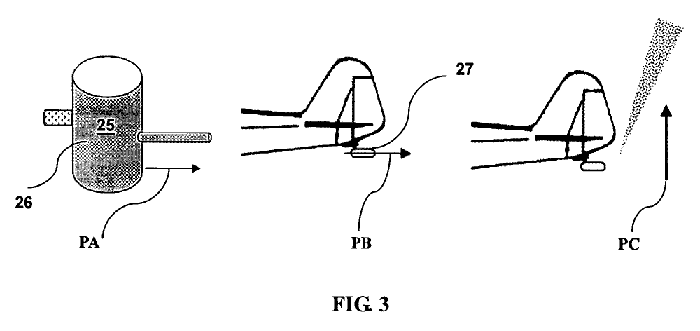

The coordinated application of the three pressures described above is illustrated in the schematic representation of FIG. 3, wherein a pressure dispersion system is shown that is based on the sequential application of such three pressures to the composition.

In the illustration of FIG. 3, a first composition expulsion pressure (PA) is applied to the composition to move the composition (25) from a container (26) inside the aircraft to an outlet or nozzle (27) of the aircraft. Pressure (PA) can be obtained, for example, as already explained above, by mixing the composition with compressed gases in a container that is either loaded when the aircraft is on the ground or during the flight.

In the system of FIG. 3, a second pressure (PB) due to the speed of the aircraft is then applied to the composition (25) at the outlet (27) to further propel the composition outside the aircraft in a direction that tends to oppose to the direction of the flight.

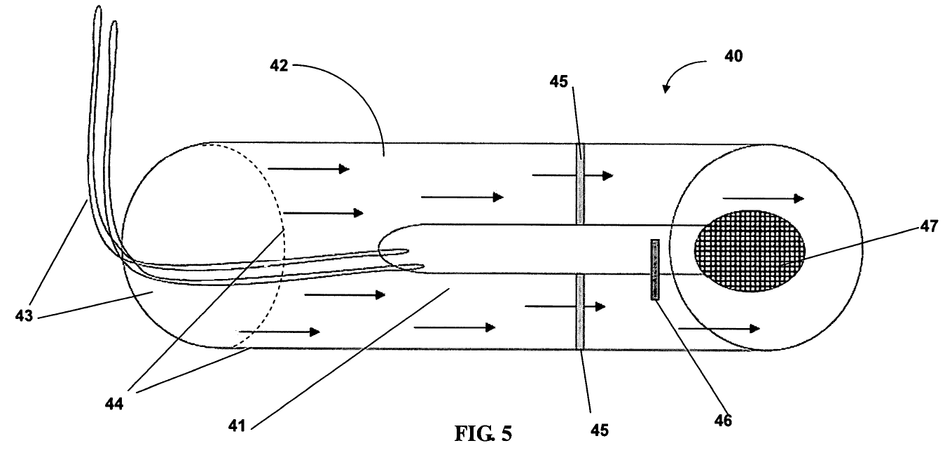

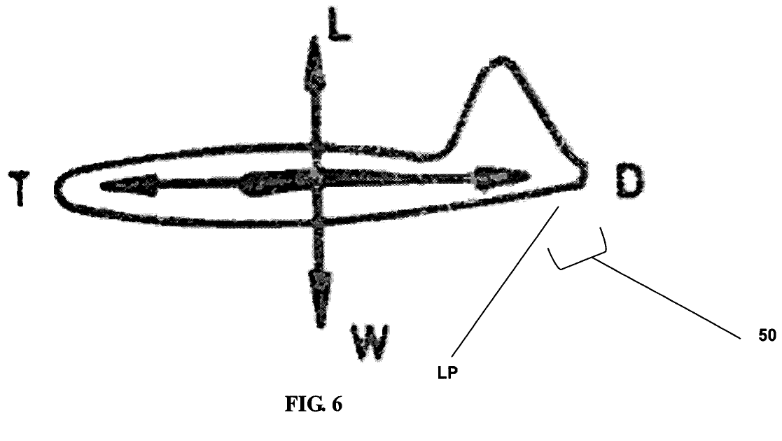

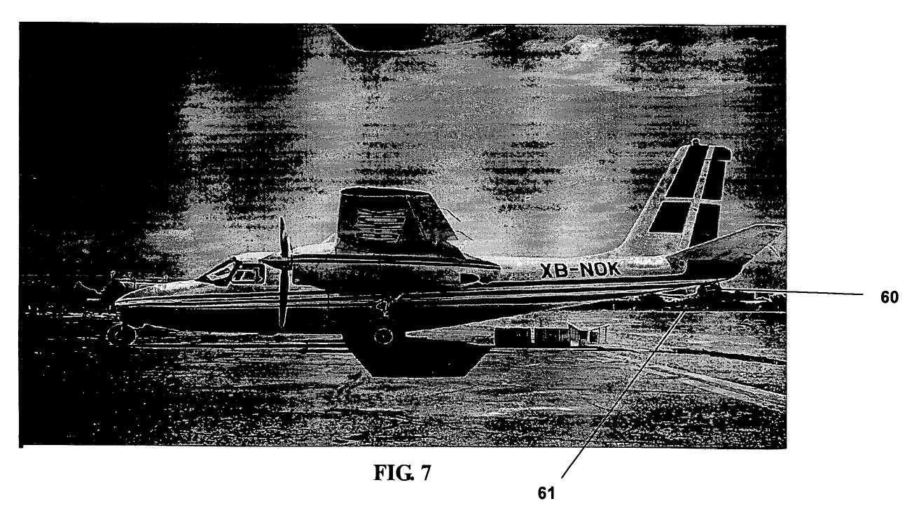

In the system of FIG. 3, a third pressure (PC) is also present, which is an ascending pressure that can be obtained by locating the outlet (27) in a location that uses the lift force generated by the dynamics of flight as further illustrated in FIGS. 6 and 7. In some embodiments, pressure (PC) can also be applied to the composition by other means, e.g. by placing the nozzle in a location of choice of the aircraft so that the nozzle aims upwards and applying the pressure using other equipment for applying pressure identifiable by a skilled person upon reading of the present disclosure (e.g., by keeping the cylinder later shown in FIG. 5 closed and hosing it to another source of pressure).

The first pressure (PA) can assume any value sufficient to expel the composition from the container and, in particular, can be in a range from about 120 psi to about 180 psi. Such first pressure (PA) can be generated through systems and equipments known to the skilled person and includes commercial compressors and hoses suitable to contain and propel air or other gases.

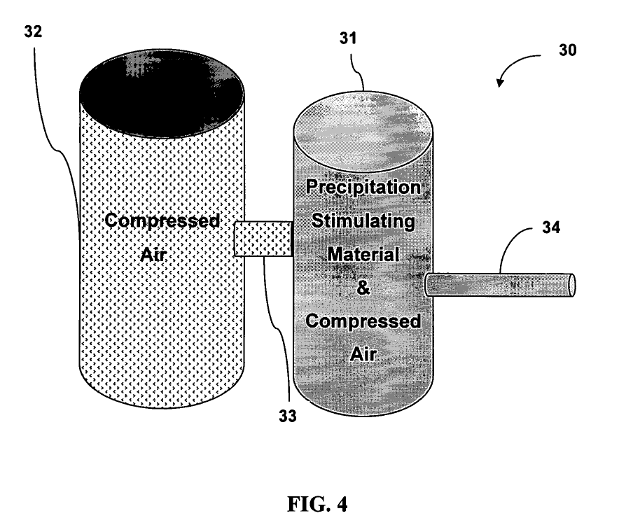

An exemplary system for applying the first pressure is shown in the schematic illustration of FIG. 4. In the system of FIG. 4, a container (31) is shown, that includes the precipitation stimulating material together with compressed air included in the container, as already mentioned above, so that a pressure between about 120 psi and about 180 psi is maintained. A container (32) is also shown, that contains compressed air at a pressure between about 120 psi and about 180 psi. In the illustration of FIG. 4, container (31) is connected to a hose (34) for transferring the material to an expulsion system (see the exemplary system later shown in FIG. 5). Container (31) is connected to container (32) through a connecting element (33) to ensure that the pressure in container (31) remains constant during operation of the system.

The second pressure, generally speaking, is a pressure that allows the first pressure to be increased. While in some embodiments such second pressure (PB) can be obtained in a way similar to the first pressure (i.e., by providing a further tank or compressor), one embodiment of the present disclosure provides such pressure by using the speed of the aircraft.

A possible realization of such embodiment is shown in the schematic illustration of FIG. 5, where an arrangement is provided to allow the air moved by the airplane to influence the composition expelled from a nozzle. The system (40) of FIG. 5 includes an aspersion nozzle (41) connected to hoses (43) and included in a cylinder (42). The hoses (43) can be the same as or be connected, for example, to the hose (34) shown in FIG. 3 and their function is that of feeding the material to be expelled to the nozzle (41). The nozzle (41) comprises a dispersion grid (47) to allow the stimulating material to be dispersed in fine drops and into a wider area, possibly together with a valve or screw (46) to regulate the amount of material dispersed by such nozzle (41).

The system of FIG. 5 can also include brackets (45) to center the nozzle (41) inside cylinder (42). In the system of FIG. 5, the second pressure (shown by horizontal arrows) derives from air (44) which is allowed to naturally enter into the open cylinder (42) that contains the aspersion nozzle (41), the intensity of which is in direct proportion to the speed at which the plane is flying. The range varies from the minimum sustentation speed of the particular aircraft being used and up to the highest speed that particular aircraft can obtain.

In some embodiments, the combined presence of both pressures can be seen as a single pressure (P1) as illustrated in FIG. 2.

As mentioned previously, a third pressure can be applied to the composition once the composition is expelled and outside the aircraft. Such third pressure can be applied as a result of forces involved in flight dynamics, as shown in the exemplary illustration of FIG. 6.

As shown in FIG. 6, 4 forces are involved during flight, Thrust (T), Drag (D), Weight (W) and Lift (L). Lift (L) is the force that causes the plane to go up. The shape of the wings and the shape of the tail tend to generate such force. The third pressure in accordance with the present disclosure is based on the naturally generated ascending pressure that occurs during flights in a lift portion (LP) of the aircraft where only such lift force (L) is applied. The lift portion exists in any aircraft and is usually located in the lower part of the fuselage in proximity of the tail portion.

In the exemplary illustration of FIG. 6, the lift portion (LP) is located within area (50). By locating the nozzle in the lift portion (LP) of the airplane, an ascending pressure will be generated, that will allow the precipitation stimulating material to be dispersed in a unique and powerful way. The third pressure range can vary from the minimum sustentation speed of the particular aircraft up to the ascending pressure associated to the highest speed that particular aircraft can obtain in a manner identifiable by the skilled person. Such pressure will also depend of the particular type of aircraft that is being used in a manner identifiable by a skilled person.

In some embodiments, application of the three pressures is performed by a system like the one illustrated in FIG. 7, where the nozzle is located within a metallic cylinder to form the aspersion system (60) located on the lift point (61). As described, the aspersion nozzle is contained in a metallic cylinder that funnels air to the nozzle, and adds the pressure that results from the plane speed (see FIG. 5). The shape and kind of plane only affects the exact location of the aspersion nozzle, but the operating principles apply to all existing aircrafts. The location of the system (60) on the lift point (61) allows application of a unique and powerful ascending pressure originating at the lift point to the composition expelled through the nozzle.

Once the organic solvent volatilizes, the temperature of the suspended crystals drops, a temperature difference with the pre-existing condition is created, and the resulting concentration of humidity in the cold particles will generate an additional temperature drop in a cascading effect that will not only cause rainfall, but also maximize the amount of moisture from the cloud that is converted into rainfall.

In some embodiments, instead of only using the principle of induced crystallization to cause rainfall, the triple pressure dispersion system described above results in dispersing the composition with sufficiently high velocity to localize the resulting chilling effect of the solvent violent evaporation in the iodide nucleus. In some of those embodiments, the consequent freezing the crystal occurs at a temperature that can cause an average temperature difference or gradient of about 80° C. below the previous temperature of the cloud. In some of those embodiments, the rainfall will be stimulated by the sudden concentration of humidity in the chilled crystal, which will produce bigger water drops, more heat expulsion and additional creation of gradient.

In several embodiments, the application of the composition on the moisture bearing atmospheric formations takes advantage of the above described three pressures, therefore being more dynamic and effective and covering a wider area than the prior art.

In some embodiments, the reaction causing the rainfall will be self sustained, a combination of all known causes of precipitation, creating larger amounts of rain, extracting more than three times the amount of humidity extracted using current methods.

### EXAMPLES

The methods and system herein disclosed are further illustrated in the following examples, which are provided by way of illustration and are not intended to be limiting.

### Example 1

### Preparation of Stimulating Material Suitable for Causing Precipitation in Cloud Formations

A composition comprising a metallic iodide crystal suspended in a organic solvent was prepared as illustrated in Table 1, where either silver iodide or lead iodide can be mixed with either ether or acetone, and sodium metasilicate can be optionally added.

TABLE 1
compositions comprising precipitation stimulating materials

| Chemical | Measure Unit | Proportion |
|---|---|---|
| Silver Iodide | Grams | 8 to 25 grams per liter of solvent |
| Lead Iodide | Grams | 8 to 25 grams per liter of solvent |
| Ether | Liters | As needed |
| Acetone | Liters | As needed |
| Sodium Metasilicate | Milliliters | Up to 3 ml per liter |
| (This will be a 0.1 | | |
| normal solution) | | |

### Example 2

### Preparation of a Milled Precipitation of Stimulating Material Suitable for Causing Precipitation in Cloud Formations

A composition comprising a metallic iodide crystal as above suspended in an organic solvent as above was prepared as described hereinafter. In particular, lumps of silver or lead iodides are initially obtained in a desired amount. After that, the lumps are put into a laboratory industrial grade mill, where the temperature is being kept between about 60° C. and about 147° C. during milling, to control hydric and electronic avidity of the metallic iodide. Further to this, the mixture is cooled either at room temperature or by use of artificial refrigeration until it reaches a temperature below 53.56° C. (boiling temperature of acetone), e.g., 40° C. Once such temperature is reached, the iodide is immersed into acetone with a desired proportion. At this time, sodium metasilicate can optionally be mixed with the composition. After that, the container is lightly shaken or stirred with a wooden or metallic (e.g., steel) device. Once this is done, the suspension is put to rest for about an hour, in order to become homogeneous. The composition is now ready for storage in proper containers or ready to be put in the tanks for application.

### Example 3

### Method and System to Stimulate Precipitation in Cloud Formations

A composition as described in Example 1 and prepared as in Example 2 can be aspersed on cloud formations from an airplane configured to include a tank comprising the composition and an aspersion nozzle located inside a 30 cm long tube, the tube being open on both sides. In particular, the tank and the nozzle can be mounted on the plane to allow application of the following 3 pressures:

a) A delivery pressure applied to the composition to deliver the composition from the tank to the aspersion nozzle by compressed air inside the tank;

b) A pressure applied to the composition to deliver the composition from the aspersion nozzle to the outside of the plane by mounting the aspersion nozzle on the plane, so that it aims in the same direction of the plane flight, thus adding more pressure, proportional to the speed of the plane; and

c) A pressure applied to the composition once outside of the plane to impress high velocity to the composition, as a result of the location of the aspersion nozzle on the tail of the plane, and in particular on the precise point where the flight generates only ascending pressure, equally proportional to the speed of the plane.

The sum of these 3 different sources of pressure results in an extremely increased dispersion speed, while also exponentially increasing the stimulated surface, resulting in a stimulation far more efficient than the methods used in the art.

The results of the aspersion of the compositions of Examples 1 and 2 are illustrated in Table 2, each of which will determine the best outcome for the rain based on existing conditions.

TABLE 2

| | | | | | | | Expected |
|---|---|---|---|---|---|---|---|
| | | Using | | | | | result, |
| Using | Using | milling and | Using Ether | Using | | Use of sum of | classified as |
| Silver | Lead | mixing | as volatile | Acetone as | Using Sodium | 3 pressures | best, |
| Iodide | Iodide | process | agent | volatile agent | Metasilicate | to apply | preferred, |
| YES | NO | YES | YES | NO | YES | YES | GOOD |
| YES | NO | YES | YES | NO | YES | NO | SC WATER |
| YES | NO | YES | YES | NO | NO | NO | SC WATER |
| YES | NO | YES | YES | NO | NO | YES | GOOD |
| YES | NO | YES | NO | YES | YES | YES | GOOD |
| YES | NO | YES | NO | YES | YES | NO | SC WATER |
| YES | NO | YES | NO | YES | NO | NO | SC WATER |
| YES | NO | YES | NO | YES | NO | YES | GOOD |
| NO | YES | YES | YES | NO | YES | YES | PREFERRED |
| | | | | | | | FORMULA |
| | | | | | | | DIFFICULT TO |
| | | | | | | | HANDLE |
| NO | YES | YES | YES | NO | YES | NO | SC WATER |
| NO | YES | YES | YES | NO | NO | NO | SC WATER |
| NO | YES | YES | YES | NO | NO | YES | GOOD |
| NO | YES | YES | NO | YES | YES | YES | BEST |
| | | | | | | | FORMULA FOR |
| | | | | | | | ALL CASES |
| NO | YES | YES | NO | YES | YES | NO | SC WATER |
| NO | YES | YES | NO | YES | NO | NO | SC WATER |
| NO | YES | YES | NO | YES | NO | YES | GOOD |

In view of the results of Table 2 it is observed that:
1) the milled composition results in a very stable and efficient formula, where all crystals are capable to coalesce with water, therefore resulting in a significant increase in the water drops
2) the milled composition induces rainfall independently of whether the three pressures are used or not, and therefore can be applied successfully using principles such as induced crystallization, and/or temperature gradient.
3) Using the three pressures, the treated area is maximized, and also the gradient is maximized, therefore achieving a dramatic increase in the amount of rainfall produced.

In all cases, for optimum results, the solvents can be of pharmaceutical grade, and the iodides should be in the form of fine crystals, which most cases remain disaggregated until the moment of application.

It should be mentioned that no combustion is contemplated for the above cases, so there is no increment in temperature during the reaction. Therefore, there is more efficiency in this procedure than in others.

The example set forth above are provided to give those of ordinary skill in the art a complete disclosure and description of how to make and use the embodiments of the devices, systems and methods of the disclosure, and are not intended to limit the scope of what the inventors regard as their disclosure. Modifications of the above-described modes for carrying out the disclosure that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosures are not limited to particular compositions or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

Any methods and materials similar or equivalent to those described herein can be used in the practice for testing of the specific examples of appropriate materials and methods are described herein.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A method for stimulating a moisture-bearing atmospheric formation to cause precipitation, the method comprising:
providing a composition comprising a precipitation stimulating material and a volatile liquid vehicle, the precipitation stimulating material being substantially unsolubilized in the volatile liquid vehicle, and
contacting the composition with the moisture-bearing atmospheric formation for a time and under conditions to create a temperature difference between the moisture-bearing atmospheric formation before contact and the moisture-bearing atmospheric formation after contact, the temperature difference being from about 40° C. to about 110° C.

2. A method for stimulating a moisture-bearing atmospheric formation to cause precipitation, the method comprising:
providing a composition comprising a precipitation stimulating material and a volatile liquid vehicle, the precipitation stimulating material being substantially unsolubilized in the volatile liquid vehicle, and
contacting the composition with the moisture-bearing atmospheric formation for a time and under conditions to create a temperature difference between the moisture-bearing atmospheric formation before contact and the moisture-bearing atmospheric formation after contact, the temperature difference promoting moisture condensation in the moisture-bearing atmospheric formation, independently of the temperature of the moisture-bearing atmospheric formation.

3. A method for stimulating a moisture-bearing atmospheric formation to cause precipitation, the method comprising:
providing a composition comprising a precipitation stimulating material;
locating the composition on a flying device;
contacting the composition with the moisture-bearing atmospheric formation by subjecting the composition to one or more pressures generated by the flying device,
wherein the subjecting the composition to one or more pressures generated by the flying device creates a temperature difference between the precipitation stimulating material and the moisture-bearing atmospheric formation, said temperature difference causing precipitation independently of the temperature of the moisture-bearing atmospheric formation.

4. The method of claim 3, wherein the one or more pressures generated by the flying device include a first pressure for expelling the composition from the flying device.

5. The method of claim 4, wherein the first pressure is generated by way of compressed air.

6. The method of claim 4, wherein the one or more pressures further include a second pressure combined with the first pressure, the second pressure resulting from combination between air and flying device velocity, the second pressure aiding to expel the composition from the flying device.

7. The method of claim 6, wherein the one or more pressures further include a third pressure combined with the first and second pressure, the third pressure being an ascending pressure resulting from expelling the composition from the flying device at a lift portion location of the flying device where only a lift force is applied, during flight, to the flying device.

8. The method of claim 4, wherein the one or more pressures further include a second pressure combined with the first pressure, the second pressure resulting from expelling the composition from the flying device at a lift portion location of the flying device where only a lift force is applied to the flying device.

9. An arrangement for stimulating a moisture-bearing atmospheric formation to cause precipitation, the arrangement comprising:
a composition comprising a precipitation stimulating material;
a nozzle from which the composition is adapted to be expelled, the nozzle located on a flying device;
a pressure generation system for subjecting the composition to one or more pressures generated by the flying device to create a temperature difference between the precipitation stimulating material and the moisture-bearing atmospheric formation, the temperature difference causing precipitation independently of the temperature of the moisture-bearing atmospheric formation.

10. The arrangement of claim 9, wherein the pressure generation system comprises compressed air to expel the composition from the flying device.

11. The arrangement of claim 9, wherein the pressure generation system comprises an open cylinder containing the nozzle, the open cylinder allowing an air passage outside of the nozzle and generating, during flight, a combined air and flight velocity pressure aiding to expel the composition from the flying device.

12. The arrangement of claim 11, wherein the nozzle comprises a dispersion grid to allow the composition to be dispersed in fine drops.

13. The arrangement of claim 9, wherein the pressure generation means comprises the nozzle being located at a lift portion location of the flying device where only a lift force is applied, during flight, to the flying device.

14. A system for stimulation of moisture-bearing atmospheric formations to cause precipitation, comprising:
an aircraft, the aircraft comprising a lift portion where only lift force is applied during flight; and
a nozzle adapted to expel, during flight of the aircraft, a composition comprising a precipitation stimulating material and a volatile liquid agent, the nozzle being located on the lift portion of the aircraft,
wherein location of the nozzle on the lift portion of the aircraft allows application of an ascending pressure on the precipitation stimulating material and volatile liquid agent during flight as soon as the precipitation stimulating material and volatile liquid agent are expelled from the nozzle.

15. The system of claim 14, further comprising an open cylinder surrounding the nozzle, the open cylinder allowing an air passage outside of the nozzle and generating, during flight, a combined air and flight velocity pressure aiding to expel the precipitation stimulating material and volatile liquid agent from the aircraft.

16. A composition comprising:
a precipitation stimulating material combined with an organic solvent,
the precipitation stimulating material being selected from silver iodide in a proportion of 8 to 25 grams per liter of solvent and lead iodide in a proportion of 8 to 25 grams per liter of solvent,
the solvent being selected from ether and acetone.

17. The composition of claim 16, further comprising sodium metasilicate.

18. The composition of claim 17, wherein the sodium metasilicate is present in a proportion of up to 3 milliliters per liter of solvent.

19. A method for preparing a composition of stimulating material suitable for causing precipitation in cloud formations, comprising:
providing lumps of metallic iodide crystals;
milling the lumps of metallic iodide crystals at a temperature between about 60° C. and about 147° C. to obtain a milled mixture;
before combining the milled mixture with an organic solvent, cooling the milled mixture until the milled mixture reaches a temperature below the boiling point of the organic solvent; and
combining the cooled milled mixture with the organic solvent.

20. The method of claim 19, wherein the organic solvent is selected from acetone and ether.

21. The method of claim 19, wherein the organic solvent is acetone and wherein the milled mixture is cooled to a temperature of about 40° C.

22. The method of claim 19, further comprising mixing sodium metasilicate with the combined cooled milled mixture and organic solvent.

23. The method of claim 19, further comprising shaking or stirring the combined cooled milled mixture and organic solvent.

24. The method of claim 19, further comprising storing the combined cooled milled mixture and organic solvent in a container.

25. A method for moving a cloud under influence of a precipitation stimulating material adapted to contact the cloud, comprising:
contacting the cloud multiple times with the precipitation stimulating material to generate multiple condensation points on the cloud, wherein portions of the cloud opposite to a location of each contact move towards said location, thus resulting in movement of the cloud,
wherein the precipitation stimulating material is a material adapted to generate a 40° C. to 110° C. temperature gradient between the cloud before the contact and the cloud after the contact.
